(19) United States
(12) Patent Application Publication
(10) Pub. No.: US 2025/0231206 A1
(43) Pub. Date: Jul. 17, 2025

(54) SYSTEMS AND PROCESS FOR INTAKE AND ANALYSIS OF SAMPLES

(71) Applicant: Center Point Bio-Tech, LLC, Las Vegas, NV (US)

(72) Inventor: Tim BAUM, Las Vegas, NV (US)

(21) Appl. No.: 18/979,270

(22) Filed: Dec. 12, 2024

Related U.S. Application Data
(60) Provisional application No. 63/620,569, filed on Jan. 12, 2024.

(51) Int. Cl. G01N 35/00

(52) U.S. Cl. CPC G01N 35/00584; G01N 35/0099; G01N 2035/00356; G01N 2035/0097

(57) ABSTRACT

The disclosed system discussed herein may include systems and methods for the automated intake and analysis of biological samples. The system may receive, by a drawer of a testing device, a sample holder comprising a biological sample. The system may transport, by a robotic manipulator, the sample holder from the sample drawer to a slot within a repository. The system may maintain a predefined temperature within the repository during a growth period of the biological sample. The system may move the sample holder to an optic assembly. The system may remove, by the robotic manipulator, a coverslip from the sample holder. The system may capture, an image of the biological sample. The system may determine one or more characteristics of the biological sample. The system may execute, based on the one or more characteristics, one or more actions.

### CROSS-REFERENCE TO RELATED APPLICATIONS

This application claims the benefit of, and priority to, U.S. Provisional Patent Application No. 63/620,569, filed Jan. 12, 2024, entitled “Rapid Diagnostic Testing,” the disclosure of which is incorporated by reference in its entirety.

### TECHNICAL FIELD

The present disclosure generally relates to diagnostic testing, and more specifically to intake and analysis of samples for rapid diagnostic testing.

### BACKGROUND

In the field of diagnostic medicine, the collection and analysis of samples, such as blood, urine, and tissue, are critical for diagnosing and monitoring various health conditions. Moreover, efficiency and accuracy of sample handling may be critical to ensuring reliable results, particularly in clinical settings where rapid diagnostic feedback is essential. Conventional systems often rely on manual processes for sample intake, which may introduce variability and the risk of human error. Additionally, traditional methods of sample handling are prone to issues such as contamination, delays due to inefficient workflows, and the inability to consistently maintain optimal environmental conditions for sample preservation. The increasing demand for high-throughput diagnostic testing exacerbates these challenges, requiring systems that may manage larger volumes of samples with greater precision and automation.

Accordingly, there is a need for a system and process that streamlines the intake and analysis of diagnostic samples to ensure that samples are handled in a manner that maintains their integrity and facilitates rapid, accurate diagnosis, improving efficiency and accuracy in diagnostic testing.

### SUMMARY

Briefly described, and according to one embodiment, aspects of the present disclosure generally relate to a diagnostic device, and more specifically to intake and analysis of samples for rapid diagnostic testing.

According to some aspects, the present disclosure includes systems and methods for the automated intake and analysis of biological samples in a diagnostic setting. The systems and methods may integrate multiple mechanical, thermal, and/or optical technologies to enhance the accuracy, efficiency, and speed of diagnostic testing. A drawer mechanism may receive sample holders, which may then be transported by a robotic manipulator to designated locations within a repository. The repository may be equipped with a heating system to maintain optimal temperature conditions during a sample growth period. Once the sample reaches an optic assembly, high-quality images of the sample may be captured, e.g., using front and back lighting to enhance image contrast. The captured images may be analyzed to determine one or more characteristics of the sample. The analysis of the captured images may include comparing the images to a database of known samples (e.g., using artificial intelligence). Based on the analysis, one or more actions may be executed. The actions may include one or more of returning the sample to storage, ejecting the sample, or continuing further imaging. The process may be fully automated and may reduce or eliminate any need for manual intervention, minimizing the potential for contamination or human error, and improving the reliability and speed of diagnostic results.

For example, a sample holder containing a biological sample may be received by a drawer of a testing device. The biological sample may be sealed within the sample holder using a thixotropic adhesive. The thixotropic adhesive may securely contain the sample during transport and analysis. The thixotropic adhesive may help prevent leakage and contamination.

The sample holder may be transported from the sample drawer to a recessed cavity (e.g., a slot) within a repository using a robotic manipulator. The robotic manipulator may be operated using instructions received from a controller. The robotic manipulator may align the sample holder within the repository. The biological sample (e.g., a growth sample) may remain within the repository for a growth threshold period based on a type of the biological sample. A predefined temperature may be maintained within the repository during the growth period of the biological sample using a heater.

The sample holder may be moved to an optic assembly by the robotic manipulator. The robotic manipulator may remove a coverslip from the sample holder. An image of the biological sample may be captured by an optic assembly. The optic assembly may use front lighting and back lighting to enhance image contrast. The controller may instruct the optic assembly to focus on the biological sample prior to capturing the image.

Based on the image, one or more characteristics of the biological sample may be determined and one or more actions may be executed based on the one or more characteristics. Determining the one or more characteristics may include comparing the image to a database of known samples. The one or more actions may include returning the sample holder to the repository, ejecting the sample holder from the drawer, and/or maintaining the sample holder within the optic assembly for additional imaging.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1 illustrates an exemplary networked environment, according to various aspects of the present disclosure;

FIG. 2 illustrates an exemplary process performed by a diagnostic system according to various aspects of the present disclosure;

FIG. 3 illustrates an exemplary diagnostic device, according to various aspects of the present disclosure;

FIG. 4 illustrates an exemplary diagnostic device, according to various aspects of the present disclosure;

FIG. 5 illustrates an exemplary diagnostic device, according to various aspects of the present disclosure;

FIG. 6 illustrates an exemplary drawer apparatus, according to various aspects of the present disclosure;

FIG. 7 illustrates an exemplary robotic manipulator, according to various aspects of the present disclosure;

FIG. 8 illustrates an exemplary repository, according to various aspects of the present disclosure;

FIG. 9 illustrates an exemplary optic assembly, according to various aspects of the present disclosure;

FIG. 10 illustrates an exemplary diagnostic device, according to various aspects of the present disclosure;

FIG. 11 illustrates an exemplary diagrammatic representation of a machine in the form of a computer system according to various aspects of the present disclosure; and

FIG. 12 illustrates a schematic of an exemplary device according to various aspects of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

The embodiments described herein are not limited in application to the details set forth in the following description or illustrated in the drawings. The disclosed subject matter is capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “connected” and “coupled” are used broadly and encompass both direct and indirect connections and couplings. In addition, the terms “connected” and “coupled” are not limited to electrical, physical, or mechanical connections or couplings. As used herein, the terms “machine,” “computer,” “server,” and “work station” are not limited to a device with a single processor, but may encompass multiple devices (e.g., computers) linked in a system, devices with multiple processors, special purpose devices, devices with various peripherals and input and output devices, software acting as a computer or server, and combinations of the above.

According to some aspects, the present disclosure provides a system and method for the automated intake and analysis of biological samples. The system may utilize a combination of mechanical, optical, and thermal technologies operated under coordinated steps to streamline the diagnostic process. The system may provide consistent sample handling and deliver faster, more accurate diagnostic results.

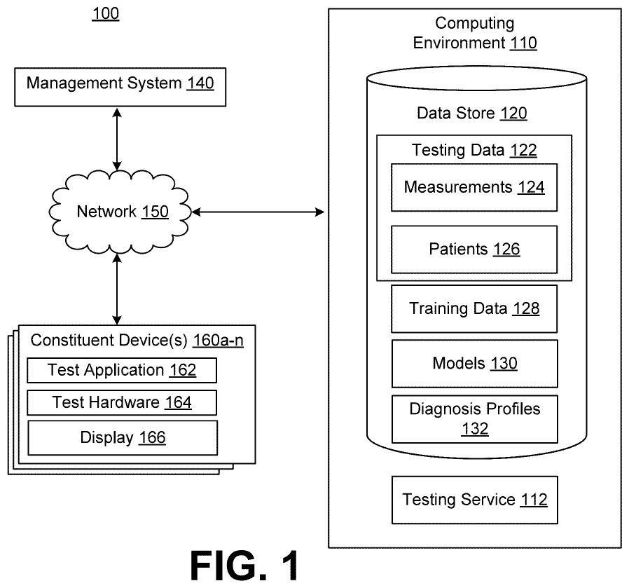

Shown in FIG. 1 is a networked environment 100 according to various aspects of the present disclosure. The networked environment 100 may include a computing environment 110, one or more constituent devices 160a-n, and a management system 140 which are in data communication with each other via a network 150. The network 150 may include, for example, the Internet, intranets, extranets, wide area networks (WANs), local area networks (LANs), wired networks, wireless networks, or other suitable networks, etc., or any combination of two or more such networks. Moreover, network 150 may include satellite networks, cable networks, Ethernet networks, Bluetooth networks, Wi-Fi networks, NFC networks, and other types of networks.

The computing environment 110 may include a data store 120 and a testing service 112. The computing environment 110 may include, for example, a server computer or any other system providing computing capability. Alternatively, the computing environment 110 may employ more than one computing device that may be arranged, for example, in one or more server banks or computer banks, or other arrangements. Such computing devices may be located in a single installation or may be distributed among many different geographical locations. For example, the computing environment 110 may include one or more computing devices that together may include a hosted computing resource, a grid computing resource and/or any other distributed computing arrangement. In some cases, the computing environment 110 may correspond to an elastic computing resource where the allotted capacity of processing, network, storage, or other computing-related resources may vary over time.

Various applications and/or other functionalities may be executed in the computing environment 110 according to various embodiments. Also, various data may be stored in a data store 120 that is accessible to the computing environment 110. The data store 120 may be representative of one or more of data stores 120 as may be appreciated. The data stored in the data store 120, for example, may associated with the operation of the various applications and/or functional entities described herein.

The components executed on the computing environment 110, for example, may include the testing service 112, and other applications, services, processes, systems, engines, or functionality not discussed in detail herein. The testing service 112 may be executed to initialize, manage, and process test results across various constituent devices 160 as communicated and interfaced with the management system 140.

The data stored in the data store 120 may include, for example, testing data 122, training data 128, models 130, and diagnosis profiles 132, among other data. The testing data 122 may include measurements 124 and patients 126. According to some aspects, the measurements 124 may include values measured for one or more patients 126 from one or more constituent devices 160. Moreover, the measurements 124 may include a timestamp associated with each measurement. For example, the measurements 124 may include multiple sets of measurements over time for patients 126. The patients 126 may include identifying information for one or more patients, such as height, weight, birth date, allergies, medical history including medicine history, diagnostic history, and a history of medical procedures.

The training data 128 may include historical measurements (e.g., measurements 124) and known diagnoses or conditions for patients (e.g., patients 126) that may be used to train the various algorithms as described herein. The models 130 may include various data for one or more artificial intelligence and machine learning models. The diagnosis profiles 132 may include profile data for one or more diagnoses. For example, a diagnosis profile 132 for heartworm may include metadata describing expected ranges or imaging results for fecal measurements, blood measurements, and other measurements from when a patient 126 does have and does not have heartworm.

The testing service 112 may communicate with the constituent devices 160 and management system 140 to coordinate testing. For example, the testing service 112 may request patient information from the management system 140, such as patient identifier, weight information, medical history, etc., and store or update the data in patients 126. The testing service 112 may transmit testing data 122 for patients 126 to the management system 140 including test results, diagnostic predictions, and error information. The testing service 112 may communicate with the constituent devices 160 to initialize parameters related to the test. For example, the testing service 112 may set a testing identifier for each specific test or set of tests, a patient identifier for the test, a list of tests to be performed, and other parameters.

The testing service 112 may receive testing results from the constituent devices 160. The testing service 112 may aggregate test results across various constituent devices 160 based on testing identifiers, patient identifiers, or other identifying information. The testing service 112 may store the test results (e.g., testing data 122). For example, the stored testing data 122 may include images, videos, audio recordings, recorded values, or other information. In one example, an image of a parasite captured from a fecal test by a constituent device 160 may be stored in measurements 124. The testing service 112 may transmit the image as part of the test results to the management system 140. The management system 140 may include a display and may render the image on a display along with the test results for a doctor and/or patient to show the parasite allowing confirmation of the diagnosis.

The constituent device 160 may be representative of one or more constituent devices that may be coupled to the network 150. The constituent device 160 may include, for example, a processor-based system such as a computer system. Such a computer system may be embodied in the form of a desktop computer, a laptop computer, an embedded processor, personal digital assistants, cellular telephones, smartphones, set-top boxes, music players, web pads, tablet computer systems, game consoles, electronic book readers, or other devices with like capability.

The constituent device 160 may execute a test application 162 and/or other applications and may include various test hardware 164. The test application 162 and various test hardware 164 may be different for each type of constituent device 160. For example, a chemistry analysis constituent device 160 may include a chemistry test application 162 and chemistry test hardware 164. As another example, a hematology analysis constituent device 160 may include a hematology test application 162 and hematology test hardware 164. The constituent device 160 may include a display 166. The display 166 may include, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The test application 162 may be executed in a constituent device 160, for example, to access network content received from the computing environment 110 and/or other servers. Moreover, the test application 162 may be rendered on one or more user interfaces on the display 166. To this end, the test application 162 may include, for example, a browser, a dedicated application, etc., and one or more user interfaces may include a network page, an application screen, etc. The constituent device 160 may execute applications beyond the test application 162 such as, for example, email applications, social networking applications, word processors, spreadsheets, and/or other applications.

The test application 162 may determine that a sample has been inserted into the test hardware 164. For example, a user may insert a sample cartridge into the test hardware 164, and the test application 162 may determine, based on an input from a sensor or an electronic circuit, that the sample cartridge has been inserted. The test application 162 may analyze the sample using one or more sensors of the test hardware 164. In some aspects, the one or more sensors of the test hardware 164 may include a spectrophotometer, a camera, a SAW detector, a fluorescence microscope, a dipstick analyzer, or other sensors.

The test hardware 164 may also include an active component, such as an emitter including a SAW emitter or a light emitter, among other emitters. The test application 162 may capture one or more measurements, such as measured values, images, sounds, or other measurements. The test application 162 may send the measurements to the testing service 112. The testing service 112 may store the measurements associated with identifying information for the specific test and patient in measurements 124. The test application 162 may render instructions for using the test hardware 164 on the display 166. The test application 162 may render the test measurements/results on the display 148.

For example, the emitter (e.g., integrated within an optic assembly) may be utilized to capture one or more measurements of a biological sample. The emitter may generate a controlled light source, providing front and/or back illumination to enhance the contrast and visibility of the features of the biological sample during imaging and provide detailed and high-quality image capture. The optic assembly may process the emitted light as it interacts with the biological sample, capturing high-resolution images for accurate diagnostic assessments. The captured images may be analyzed to determine one or more physical or chemical characteristics of the biological sample.

The testing service 112 may analyze the training data 128 including historical measurements 124 across a variety of patients 126. In some aspects, the testing service 112 may generate the training data 128 by de-identifying and aggregating the testing data 122. The testing service 112 may analyze the training data 128 using one more machine learning algorithms or artificial intelligence algorithms to generate parameters for one or more machine learning models predictive of a diagnosis. The testing service 112 may utilize a combination of algorithms to generate the predictive models 130 including nearest neighbor, neural networks, regression analysis including logistic, quadratic, linear, or other regression, decision trees, random forest models, support vector machines, Naive Bayes, k-means clustering, time series regression, pointwise prediction, stepwise regression, Gaussian mixture models, gradient boosting, and means-shift clustering, or combinations thereof.

The testing service 112 may apply one or more generated models 130 to testing data 122 to generate one or more health scores. The health scores may include a predictive score of the likelihood a patient 126 has a particular diagnosis. The testing service 112 may compare the results of the algorithms including the one or more health scores to the diagnosis profiles 132 to determine a likelihood that a patient 126 has one or more diagnoses corresponding to the diagnosis profiles 132. The testing service 112 may identify one or more diagnoses with a calculated likelihood score exceeding a predetermined threshold. The testing service 112 may rank the diagnosis profiles 132 based on the calculated likelihoods. The testing service 112 may identify a top-ranked diagnosis profile 132. The testing service 112 may transmit a particular diagnosis to the management system 140, which may include diagnoses with a calculated likelihood score exceeding the predetermined threshold, the top-ranked diagnosis profile, or some other diagnoses based on analyzing the testing data 122.

The testing service 112 may analyze previous measurements 124 and diagnoses for one or more patients 126. The testing service 112 may identify when specific measurements 124 change beyond a threshold amount and perform an action. The action may include diagnosing a condition, generating a warning for the patient 126, transmitting a notification to the management system, or some other action.

The networked environment 100 may enable the automated intake and analysis of biological samples by leveraging its interconnected components. The testing service 112, which operates within the computing environment 110, may coordinate the intake of a sample holder comprising a biological sample. The constituent devices 160, which may include the test hardware 164, may receive the sample holder. The test hardware 164 may incorporate a drawer mechanism to securely hold the sample holder. The network 150 may facilitate communication between the constituent devices 160, the testing service 112, and the management system 140, allowing for efficient coordination of sample processing tasks.

Once the sample holder is received, the testing service 112 may instruct a robotic manipulator within the test hardware 164 to transport the sample holder from the drawer to a repository. The repository may be temperature-regulated by a heater, which may maintain a predefined temperature during the growth period of the biological sample. The computing environment 110 may use testing data 122 and measurements 124 associated with the biological sample to monitor and control the conditions within the repository. Measurements 124 such as temperature, humidity, and incubation time may be stored in the data store 120 and continuously monitored by the testing service 112 to ensure optimal growth conditions.

As the growth period progresses, the robotic manipulator may move the sample holder to the optic assembly, where an image of the biological sample may be captured. The optic assembly, controlled by the test application 162, may use one or more of front lighting and/or back lighting to enhance image contrast. The captured image may be transmitted over the network 150 to the computing environment 110, where the testing service 112 may process the image. Moreover, the focus of the optic assembly may be adjusted based on instructions from the testing service 112, ensuring clear imaging of key features of the sample.

One or more characteristics of the biological sample may be determined based on information stored within the data store 120. For example, the captured image may be compared to a database of known samples stored in the diagnosis profiles 132. The diagnosis profiles 132 may be continually updated using training data 128. The training data 128 may include historical measurements 124 and known diagnoses for previous patients 126. The models 130, hosted within the computing environment 110, may utilize one or more machine learning algorithms to analyze the sample images. By applying the models 130, one or more characteristics of the biological sample may be accurately identified and the sample may be classified based on the comparison.

Based on the characteristics determined during the analysis, the testing service 112 may execute one or more actions. The actions may include one or more of returning the sample holder to the repository for further incubation, ejecting the sample holder from the drawer, or maintaining the sample holder within the optic assembly for additional imaging. The constituent devices 160 may communicate the one or more actions to the test hardware 164. The test hardware 164 may execute the actions based on instructions from the testing service 112. The results of the actions may be stored in the testing data 122 and transmitted to the management system 140 for review.

According to some aspects, the growth threshold period for the biological sample may be dynamically adjusted based on the type of sample and the diagnostic needs. The testing service 112 may retrieve relevant data from the diagnosis profiles 132 to determine the appropriate incubation time and environmental conditions. The environmental conditions may be communicated to the test hardware 164, which may adjust the heater within the repository to maintain the optimal temperature. Measurements 124, such as temperature and time, may be recorded and analyzed by the testing service 112 to determine and maintain ideal conditions for sample growth.

According to some aspects, the biological sample may be sealed within the sample holder using a thixotropic adhesive to maintain sample integrity. The test hardware 164 may apply the adhesive during the sample intake process so that the sample remains securely contained during transport and analysis. The testing service 112 may monitor the application and removal of the adhesive, ensuring that it does not interfere with the imaging or handling of the sample. Data related to the application of the adhesive may be stored in the testing data 122 and used for quality control purposes.

The computing environment 110 may support a feedback loop for refining the models 130 used in diagnosing the biological samples. As new data is generated from ongoing sample analysis, the training data 128 may be continuously updated to improve the accuracy and reliability of the models 130. The testing service 112 may apply the updated models to each new sample, ensuring that the system adapts to evolving diagnostic patterns and trends. The data store 120 may maintain a comprehensive record of both the training data 128 and the resulting model updates, allowing for ongoing system improvements.

The display 166 on the constituent devices 160 may provide real-time feedback to users during the sample analysis process. Information such as the current status of the sample holder, the progress of the imaging process, an/or any actions being taken by the robotic manipulator may be displayed to the user. The test application 162, running on the constituent devices 160, may allow users to interact with the system, input sample-specific data, and/or review test results. The test measurements, stored as part of the testing data 122, may be rendered on the display 166 to provide users with immediate access to critical diagnostic information.

The management system 140, connected via the network 150, may coordinate the flow of information between the testing service 112 and external systems, such as healthcare providers or research institutions. For example, once the analysis of the biological sample is complete, the results, including the captured images and diagnostic conclusions, may be transmitted to the management system 140. The test data may be securely stored, shared, and made accessible to authorized users, facilitating clinical decision-making and research efforts. Moreover, the network 150 may facilitate efficient and secure transmission of the data, e.g., in compliance with industry standards for data protection.

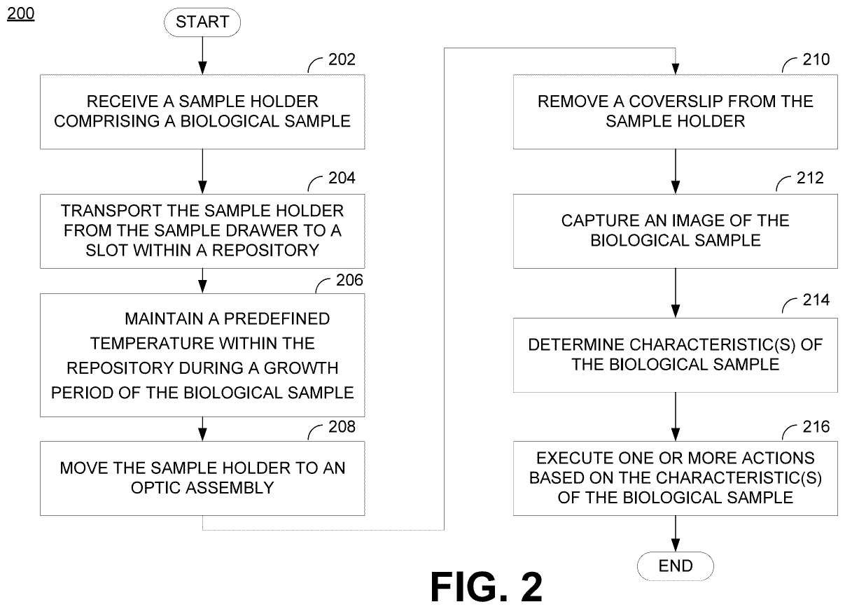

Before turning to the process flow diagrams of FIG. 2, it is noted that embodiments described herein may be practiced using an alternative order of the steps illustrated in FIG. 2. That is, the process flows illustrated in FIG. 2 are provided as examples only, and the embodiments may be practiced using process flows that differ from those illustrated. Additionally, it is noted that not all steps are required in every embodiment. In other words, one or more of the steps may be omitted or replaced, without departing from the spirit and scope of the embodiments. Further, steps may be performed in different orders, in parallel with one another, or omitted entirely, and/or certain additional steps may be performed without departing from the scope of the embodiments.

With reference to FIG. 2, shown is a flow chart of a process 200 according to various embodiments of the present disclosure. The process 200 may be performed by one or more components of a diagnostic system, including one or more components of the networked environment 100, including the computing environment 110, constituent device(s) 160, and/or management system 140.

At step 202, the process 200 may include receiving a sample holder comprising a biological sample. According to some aspects, upon receipt of the sample holder, presence of the sample holder may be detected through one or more input signals from sensors embedded in the drawer mechanism. For example, the sensors may include optical, magnetic, or mechanical switches that may confirm the placement of the sample holder and/or trigger subsequent computational actions.

According to some aspects, one or more protocols may be determined based on the type of biological sample detected. For example, in some aspects, a barcode or RFID data associated with the sample holder may be used to determine a type of biological sample. In another example, the type of biological sample may be received as an input from a user. Determined or received data may include predefined metadata associated with the sample type, required tests, and/or handling instructions. The metadata may be used to determine necessary conditions for sample preservation and analysis, such as temperature settings, incubation times, and/or specific robotic movements needed to transfer the sample holder to the next stage of analysis.

Based on the detection of the sample holder, one or more may be sent to various components of the diagnostic system. For example, the ECU may send activation signals to a robotic manipulator to transport the sample holder to a specified repository slot. Moreover, one or more environmental controls may be adjusted within the diagnostic system, such as heating or cooling elements, to prepare the repository for arrival of the sample. Furthermore, the diagnostic system may generate logs or updates for the user interface, providing real-time feedback on the status of the sample intake process. This integrated approach may ensure that the sample handling is both precise and aligned with the required diagnostic protocols, enhancing the efficiency and accuracy of the testing process.

At step 204, the process 200 may include transporting the sample holder from the sample drawer to a recessed cavity (e.g., a slot) within a repository. The diagnostic system may receive one or more input signals from sensor(s) that detect the presence and correct positioning of the sample holder within the drawer. Upon confirmation, a motorized mechanism may be activated (e.g., stepper motors or servo motors) which may be precisely controlled to ensure smooth transportation. The required movement may be determined based on pre-programmed positions of the drawer and repository slots, e.g., adjusting for any real-time feedback from position sensors to accommodate variations in alignment or mechanical drift.

According to some aspects, one or more sensors and/or encoders may continually monitor the status of the sample holder as it moves along the transport pathway. Real-time data may be provided to the diagnostic system, which may dynamically adjust motor speeds and verify trajectory paths based on the received data. One or more movements of the sample holder may be logged (e.g., for maintenance and audit purposes), including timestamps and any error codes that might indicate potential issues in the diagnostic system.

Upon successful placement of the sample holder into the repository slot, output signals from proximity or optical sensors may confirm the final position of the sample holder. The diagnostic system may update one or more inventory records to reflect the new location of the sample holder, thereby maintaining accurate tracking of sample locations for subsequent retrieval and analysis. According to some aspects, the diagnostic system may determine an optimal path and/or speed for future movements based on historical data from similar operations, thereby enhancing overall efficiency and reducing the wear on mechanical components. This adaptive approach may allow for continuous improvement in system performance, providing further reliability and accuracy in handling delicate biological samples.

At step 206, the process 200 may include maintaining a predefined temperature within the repository during a growth period of the biological sample. According to some aspects, temperature data may be received from thermal sensors located within the repository. The thermal sensors may continuously monitor the internal temperature of the repository, providing real-time data to the diagnostic system. According to some aspects, the diagnostic system may determine whether a current temperature aligns with one or more predefined settings for a specific type of biological sample being incubated. If discrepancies are detected, the diagnostic system may determine the necessary adjustments and send signals to the heating or cooling elements to stabilize the temperature.

Moreover, the diagnostic system may consider external factors that may influence the internal environment of the repository, such as ambient temperature changes or heat generated by other components within the diagnostic device. The external factors may be determined based on inputs from one or more additional sensors (e.g., ambient temperature sensor, diagnostic device sensers, etc.) to provide precise temperature control. For example, if a sudden rise in ambient temperature is detected by an ambient temperature sensor, the diagnostic system may preemptively cool the repository slightly below the set point to counteract this effect.

One or more feedback loops may continuously recalculate and/or adjust temperature settings based on the latest sensor readings. This dynamic response may maintain an ideal growth environment for the biological samples to enhance integrity and reliability of diagnostic results derived from the samples.

At step 208, the process 200 may include moving the sample holder to an optic assembly. For example, the diagnostic system may engage the robotic manipulator to move the sample holder from the repository slot to the optic assembly. Upon initiating the movement, the diagnostic system may transmit a set of input signals to the robotic manipulator, specifying both the target location and the speed profile for the transfer. The inputs may be derived from positional data of the sample holder, gathered through position sensors embedded within the repository. The control system may continuously monitor feedback signals from one or more encoders of the robotic manipulator, allowing real-time adjustments to maintain an accurate trajectory toward the optic assembly, including accounting for potential alignment discrepancies.

The diagnostic system may process environmental and/or spatial data to ensure that the path of the sample holder remains clear and optimized for minimal vibration. For example, input from load sensors may confirm secure engagement of the sample holder with the robotic manipulator, preventing inadvertent dislodgement. The diagnostic system may adjust motor speeds and/or activate dampening mechanisms to reduce the impact of external forces, e.g., using pre-determined thresholds for vibration tolerance. The adjustments may be based on real-time sensor feedback and/or pre-programmed parameters, allowing the manipulator to maintain a controlled path and preserve the sample integrity as it approaches the optic assembly.

Upon arrival at the optic assembly, the diagnostic system may verify the exact position of the sample holder relative to the optic lenses. The verification may include comparing real-time position data from optical or magnetic sensors within the optic assembly to one or more expected coordinates. If misalignment is detected, corrective signals may be sent to the robotic manipulator, enabling micro-adjustments to achieve precise alignment. The sample holder may be optimally aligned for subsequent imaging. Moreover, a readiness signal may indicate successful placement and/or initiate the imaging sequence.

At step 210, the process 200 may include removing a coverslip from the sample holder to prepare the biological sample for subsequent imaging or analysis. According to some aspects, the diagnostic system may receive one or more input signals from sensors that confirm the precise location and/or orientation of the sample holder within the robotic manipulator. Once verified, the diagnostic system may determine one or more movements required for the robotic arm or other mechanical interfaces to effectively remove the coverslip without disturbing the sample. For example, one or more parameters may include a force needed to lift the coverslip, an angle of approach to prevent any contact with the sample, and/or a trajectory to place the coverslip in a designated storage area.

Moreover, the diagnostic system may activate one or more specific components of the diagnostic system to remove the coverslip. For example, one or more actuators may receive signals to engage and carefully lift the coverslip using a predefined grip and lift mechanism optimized for maintaining sample integrity. The diagnostic system may monitor feedback from one or more touch-sensitive or pressure-sensitive sensors to dynamically adjust the grip strength, ensuring that the coverslip is handled delicately to avoid any potential damage or spillage of the sample. The sensors may provide real-time data to the diagnostic system, which may continuously recalculate and adjust one or more operational parameters to enhance precision and safety during the removal process.

Once the coverslip is removed, the diagnostic system may determine one or more subsequent steps based on the condition of the sample and/or the coverslip. For example, if sensors detect any residue or contamination on the coverslip, the diagnostic system may initiate a cleaning protocol or alert the user for manual intervention. Moreover, if the sample requires further processing without the coverslip, the diagnostic system may send commands to proceed with transporting the sample holder to the next station, such as an imaging or analysis unit. The diagnostic system may log all actions and sensor readings to facilitate traceability and ensure compliance with standard operating procedures, thereby maintaining the integrity and reliability of the diagnostic process.

At step 212, the process 200 may include capturing an image of the biological sample. According to some aspects, an optic assembly of the diagnostic system may include one or more high-resolution cameras. The diagnostic system may initiate an imaging sequence based on one or more specific parameters, such as focus settings, lighting levels, and/or image capture timings. The parameters may be determined based on one or more actual or anticipated physical or chemical properties of the sample. For example, if the sample is known to have fluorescent characteristics, the diagnostic system may adjust the optical filters and lighting to enhance the fluorescent features in the captured image.

As the imaging process begins, one or more sensors within the optic assembly may provide real-time data about the position and/or alignment of the sample relative to the camera lenses. The data may ensure that the sample is within an optimal focus range. The optical focus range may be determined based on maximizing image clarity and detail resolution. According to some aspects, one or more input signals may be received from the positioning sensors and the camera focus may be adjusted dynamically to correct for any minute misalignments or shifts that may occur during sample handling. For example, if the sample shifts slightly due to mechanical vibrations, the diagnostic system may recalculate the focus depth and realign the optical path, ensuring that the image quality is not compromised.

Upon capturing the image, the diagnostic system may process the image to enhance the image and extract relevant features. For example, the diagnostic system may perform edge detection for cell boundaries or color analysis for chemical staining. Output signals representing the image characteristics may be generated, including triggering further actions within the diagnostic process, such as additional imaging under different conditions or progressing to analytical assessments based on the image data. The diagnostic system may store all imaging parameters and results in a central database, allowing for continuous learning and adjustment of imaging techniques based on historical performance and diagnostic outcomes, thereby optimizing the accuracy and reliability of the imaging capabilities of the diagnostic system.

At step 214, the process 200 may include determining one or more characteristics of the biological sample. One or more image processing algorithms may be applied to analyze features of the captured image, such as cell morphology, staining patterns, or other relevant biomarkers. For example, image segmentation techniques may be used to isolate specific cells or structures within the biological sample, and quantitative analysis may measure dimensions, count cells, or evaluate staining intensities, providing critical data for disease diagnosis or health assessments.

According to some aspects, diagnostic system may use one or more machine learning models trained on a vast database of known sample images. The machine learning models may be used to classify the biological sample into diagnostic categories or to predict the presence of specific conditions. Each image may serve as an input to the machine learning models, which be used to determine probabilities or classifications based on learned patterns. Based on the analysis, one or more anomalies may be identified, such as malignant cells in a cancer screening or bacteria in an infection test. For example, the diagnostic system may use a convolutional neural network (CNN) to detect abnormal growth patterns in tissue samples, offering a preliminary diagnosis that guides further medical intervention.

According to some aspects, the characteristics determined by the diagnostic system may include biochemical properties derived from spectroscopic analysis integrated within the optic assembly. For example, the optic assembly may use fluorescence or Raman spectroscopy to determine a concentration of specific biochemicals or the presence of molecular bonds by analyzing the spectra obtained from the sample. Moreover, Fourier Transform analysis or multivariate calibration techniques may be used to convert spectral data into meaningful diagnostic information. One or more reports may be generated based on the biochemical composition of the biological sample, enhancing the understanding of the state of the biological sample or progression of a disease. The determined characteristics of the biological sample may be used to confirm a diagnosis, understand a disease mechanism, and/or monitor the effectiveness of a treatment regimen.

At step 216, the process 200 may include executing one or more actions based on the characteristics of the biological sample. One or more inputs, calculations, and determinations (e.g., determined in the previous steps of the process 200) may be used to determine precise and tailored responses to the analysis results. For example, the inputs may include biological, chemical, and/or physical properties identified through imaging and diagnostic tests, such as the presence of specific biomarkers, cell counts, or morphological details.

The diagnostic system may utilize one or more decision-making algorithms to determine the appropriate actions based on the input characteristics. For example, if the sample analysis reveals the presence of a pathogenic microorganism at levels above a clinical threshold, the diagnostic system may determine a need for further diagnostic tests or alert medical personnel for urgent intervention. The determinations may be based on one or more predefined rules or machine learning models that have been trained on historical data to associate specific sample characteristics with corresponding actions.

One or more actions may be executed, such as returning the sample holder to the repository for further incubation if the initial results are inconclusive or more growth is needed for clearer results; ejecting the sample holder from the system if the analysis concludes the sample processing; or retaining the sample in the optic assembly for additional imaging or more detailed analysis. According to some aspects, each action may be triggered by one or more sample characteristics, including issuing one or more commands to the robotic manipulator or other system components to carry out any necessary movements or adjustments. This integrated response may ensure that the sample is handled efficiently and effectively, minimizing the risk of error and maximizing the accuracy and reliability of the diagnostic outcomes.

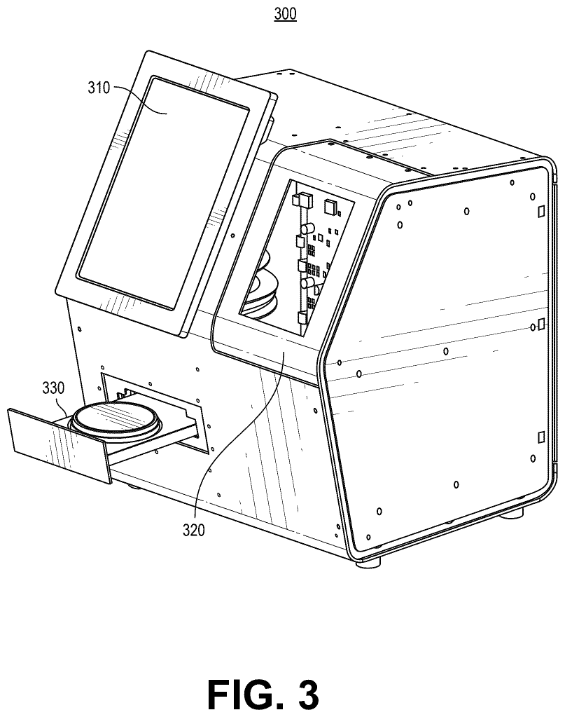

Shown in FIG. 3 is an exemplary diagnostic system 300 that may perform the process 200 for the automated intake and analysis of biological samples. Diagnostic system 300 may include a display 310, a door 320, and a drawer 330. Diagnostic system 300 may be used for testing biological samples to accurately analyze and evaluate specimens such as blood, urine, tissue, and other bodily fluids. Diagnostic system 300 may detect, diagnose, and monitor various medical conditions and diseases. The diagnostic system 300 may employ a range of technologies, including biochemical assays, immunoassays, molecular diagnostics, and imaging techniques, to provide precise and timely information about the presence of pathogens, biomarkers, genetic mutations, or other indicators of health and disease. By facilitating rapid and reliable testing, the diagnostic system may guide clinical decision-making, enable early detection and intervention, improve patient outcomes, and support ongoing medical research and public health efforts.

The display 310 on the diagnostic system 300 may serve as a user interface, providing users with essential information and control options during the diagnostic process. In some aspects the display 310 may be a touch display, allowing users to interact directly with the diagnostic system 300. The display 310 may allow users to navigate menus, select tests, and input data with ease and efficiency. The display 310 may show real-time data, results, and status updates, ensuring users have immediate access to critical information. Display 310 may be of various sizes and resolutions to accommodate user needs and preferences. Some aspects may provide the inclusion of color or monochrome options for different applications, and the incorporation of additional features such as gesture recognition or voice command support to enhance user interaction. Furthermore, the display 310 may be designed with different levels of touch sensitivity, offering options like multi-touch capability for more advanced control and user experience.

The door 320 on the diagnostic system 300 may provide secure and controlled access to the interior of the diagnostic system 300, where diagnostic components and samples may be housed. The door 320 may allow users to access the diagnostic components inside diagnostic system 300 for maintenance or other times where human intervention within the diagnostic testing is necessary. The door 320 may provide a proper seal when closed, preventing contamination and protecting sensitive components from external factors such as dust and moisture. In some aspects, the door 320 may feature a window, allowing users to visually monitor the internal processes without opening the door, thereby maintaining the sealed environment. This combination of accessibility, protection, and visibility may enhance the functionality and reliability of the diagnostic system 300, ensuring that samples remain uncontaminated and that users may efficiently manage diagnostic procedures.

Diagnostic system 300 may include a sample receiving compartment such as drawer 330. The drawer 330 may receive and house biological samples for analysis. Drawer 330 may provide a reliable and efficient mechanism for the containment, protection, and easy retrieval of these samples during diagnostic procedures. The drawer 330 may also secure biological samples for analysis by an optic assembly. The drawer 330 may include a body forming a sample receiving compartment, where biological samples such as blood, urine, or tissue specimens may be safely placed for testing.

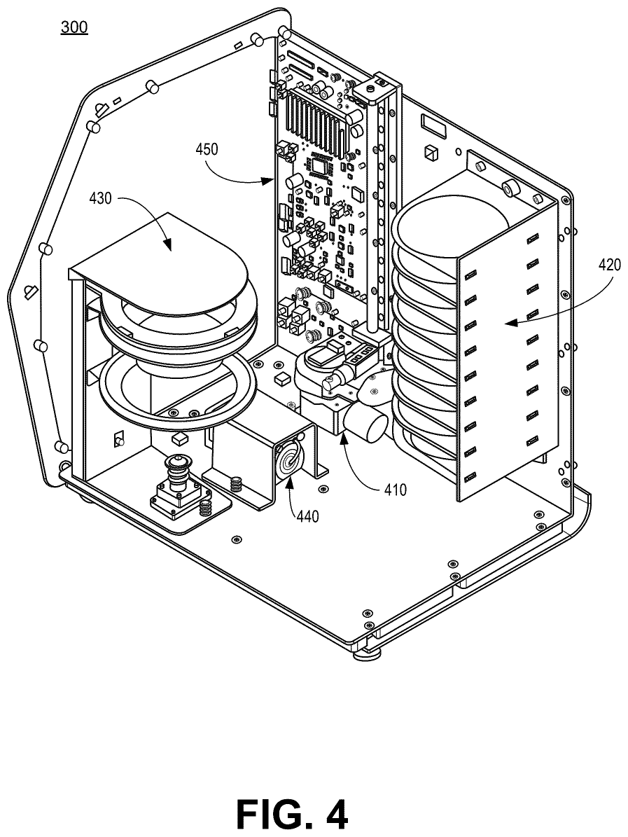

With reference to FIG. 4, shown is diagnostic system 300 which may house a robotic manipulator 410, repository 420, optic assembly 430, and a heater 440. The robotic manipulator 410 may be attached on the same wall of the diagnostic system 300 as the repository 420. The diagnostic system 300 may also house a printed circuit board assembly (PCBA) 450. The PCBA 450 may include a system-on-module that contains a controller that is in electronic communication with various components of diagnostic system 300, such as robotic manipulator 410, repository 420, optic assembly 430, and heater 440.

The diagnostic system 300 may perform the automated intake and analysis of biological samples orchestrated by the controller of PCBA 450. The diagnostic system 300 may receive a sample holder containing a biological sample using the drawer 330. The drawer 330 may include a body forming a sample receiving compartment, where biological samples such as blood, urine, or tissue specimens may be safely placed for testing. Drawer 330 may provide a reliable and efficient mechanism for the containment, protection, and easy retrieval of samples during diagnostic procedures. The drawer 330 may also secure biological samples for analysis by the optic assembly 430.

The diagnostic system 300 may transport the sample holder 530 to various locations within diagnostic system 300 using robotic manipulator 410. For example, the diagnostic system 300 may transport sample holder 530 from the sample drawer 330 to a recessed cavity (e.g., a slot) within a repository 420 using the robotic manipulator 410. The robotic manipulator 410 may include a first gripping arm that is defined by a first length. The first gripping arm may have a first roller located at a first distal end of the gripping arm, and a second roller positioned at another location along the first gripping arm. The robotic manipulator may further include a second gripping arm defined by a second length that is less than the first length of the first gripping arm. The differing lengths of the first and second gripping arm may facilitate the centering of sample holder 530 between the gripping arms when the gripping arms close in on the sample holder 530. The second gripping arm may include a third roller mounted at a first distal end of the second gripping arm. A second distal end of the first gripping arm may be pivotally connected about a first axis to a second distal end of the second gripping arm. The robotic assembly may utilize a plurality of compression springs associated with providing tension between the first gripping arm and the second gripping arm. An actuator attached to the first and to the second gripping arm may counteract the tension provided by the compression springs by extending from a first length to a second length.

The diagnostic system 300 may maintain a predefined temperature within the repository during a growth period of the biological sample using heater 440. Heater 440 may be used to regulate the temperature within diagnostic system 300. The temperature regulation may be used to incubate diagnostic samples that are stored within repository 420. The incubation temperature may be determined based on the type of the biological sample and the growth threshold period. The controller may be programmed to adjust the temperature based on the type of biological sample being incubated, ensuring optimal growth conditions. In some aspects, heater 440 may be a Peltier-based thermoelectric heater capable of rapid heating and cooling the interior of diagnostic system 300. The heater 440 may be controlled by the controller of PCBA 450, allowing for accurate setting and maintenance of the desired incubation temperature. The heater may provide a uniform temperature distribution within repository 420, preventing hot or cold spots that could adversely affect the biological samples. In some aspects, the heater 440 may include a cover to protect the heater 440 from the moving components within the diagnostic system 300. Heater 440 and the cover may be attached to the base of diagnostic system 300 via one or more screws.

The diagnostic system 300 may move sample holder 530 to an optic assembly 430 using the robotic manipulator 410. The robotic manipulator 410 may remove a coverslip from the sample holder 530 allowing the optic assembly 430 to analyze the biological sample. The optic assembly 430 may be used to perform a variety of optical analyses in order to assess the characteristics of the biological sample contained in sample holder 530. For example, the optic assembly 430 may perform urine microscopy. In some embodiments, optic assembly 430 may include a microscope equipped with a surface acoustic wave (SAW) detector and multiple cameras positioned at different angles relative to the sample holder 530 in order to capture images of the biological sample. The multiple cameras may be imaging devices of the same or different types. Imaging devices may be CCD cameras, arrays of photomultiplier tubes, or other suitable imaging devices. The imaging devices may include multiple reconfigurable lenses to allow for adjustable zoom. The controller of PCBA 450 may adjust the optic assembly to focus on the biological sample. The optic assembly 430 may capture multiple images of the sample holder 530 at different focal planes to generate a holographic representation of the sample. In some embodiments, optic assembly 430 may utilize front lighting and back lighting to enhance image contrast. Other optical analyses performed by optic assembly 430 may include but are not limited to brightfield microscopy, hematology imaging, fluorescence microscopy, phase-contrast microscopy, confocal microscopy, digital holographic microscopy, immunology analysis, spectrophotometric analysis, image cytometry, and polarized light microscopy.

The diagnostic system 300 may determine, based on the images, one or more characteristics of the biological sample. In some embodiments, the diagnostic system 300 may compare the images to a database of known samples in order to determine the characteristics of the biological sample. The diagnostic system 300 may utilize artificial intelligence in determining the characteristics of the biological sample. For example, the artificial intelligence training process may include obtaining training images of known types of blood cells. Training data may be obtained from third party databases or by providing the hematology imaging system with samples of known blood cell types. The artificial intelligence training process may include partitioning the training data into training and testing sets. The artificial intelligence training process may include providing a model with a labeled set of training data. The artificial intelligence training process may include validating a trained model using an unlabeled testing set.

The diagnostic system 300 may execute one or more actions based on the one or more characteristics. For example, the robotic manipulator 410 may return the sample holder 530 to the repository 420. The diagnostic system 300 may eject the sample holder 530 from the drawer 330. The diagnostic system 300 may maintain the sample holder 530 within the optic assembly 430 for additional imaging.

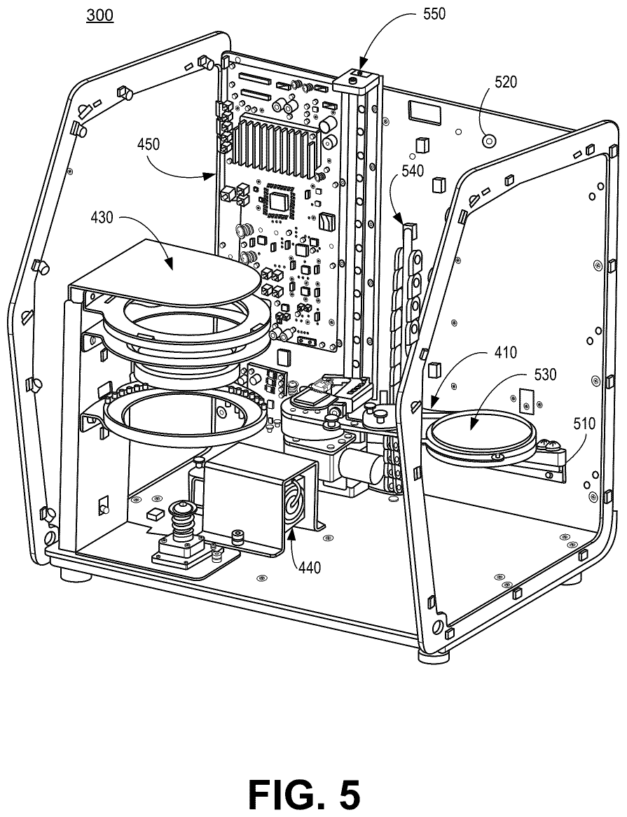

Shown in FIG. 5 is another angle of exemplary components of diagnostic system 300. FIG. 5 omits the repository 420 to better show the components of robotic manipulator 410. As shown in FIG. 5, the back wall of diagnostic system 300 may include a spring latch 510 that is used as a repository retainer for repository 420. The back wall of diagnostic system 300 may also include alignment feature 404. In some aspects, the alignment features 520 may include one or more spools.

In some aspects, the heater 440 may include a cover to protect the heater from the moving components within diagnostic system 300. The heater 440 may be attached to diagnostic system 300 on the base via one or more screws. The cover may also be attached to the base of diagnostic system 300 via one or more screws.

In some aspects, optic assembly 430 may be attached to diagnostic system 300 adjacent to heater 440. Optic assembly 430 may be positioned higher than heater 440 to allow robotic manipulator 410 to rotate about a z-axis to place a sample holder 530 in view of optic assembly 430.

In some aspects, robotic manipulator 410 may utilize an e-chain 540 and gantry 550 to enable the robotic manipulator 410 to travel up and down the z-axis. The e-chain 540 may include a flexible, chain-like structure made of interconnected links that house and protect cables, hoses, and wires. The e-chain 540 may provide a safe and organized way to manage the movement of these components, preventing tangling, abrasion, and damage. The e-chain 540 may move along a z-axis, guiding and protecting the cables as the machinery moves. The robotic manipulator 410 may rotate about the z-axis using a motor. The e-chain 540 may maintain the integrity of the cables, ensuring they remain operational over time. The gantry 550 may be a structure that spans an area on the back wall of diagnostic system 300 and may support equipment of robotic manipulator 410. The gantry 550 may include two upright beams and a horizontal beam connecting them. The gantry 550 may provide a stable framework for robotic manipulator 410 to move along the z-axis.

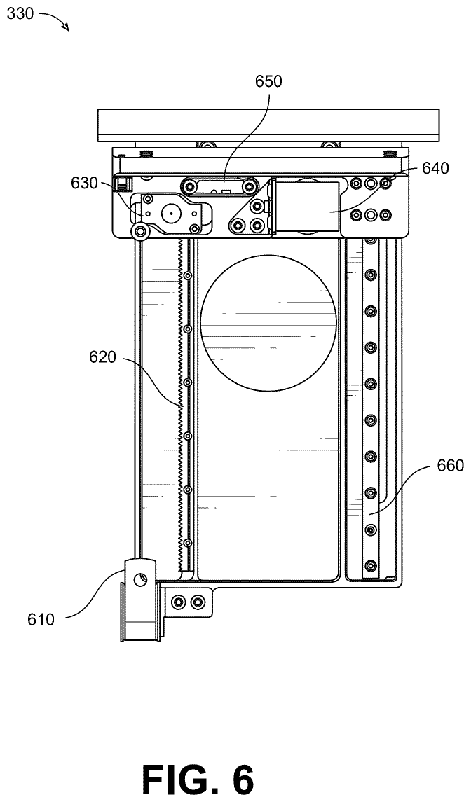

With reference to FIG. 6, shown is the underside of drawer 330. The mechanisms that enable drawer 330 to operate may be seen. A constant force spring 610 may be coupled with the gear rack 620 to uniformly modulate a retraction force of the drawer 330. The constant force spring 610 may ensure that the drawer 330 may be smoothly and consistently retracted into the housing, even when subjected to varying loads. In some aspects, the constant force spring 610 may be enclosed within a casing affixed to the body, protecting it from external environmental factors that could affect its performance.

Rotary damper 630 may dampen kinetic energy associated with the movement of the drawer 330, ensuring smooth and controlled operation. The rotary damper 630 may absorb excess energy, preventing abrupt stops or movements that could damage the sample or the apparatus. In some aspects, the rotary damper 630 may be adjustable to allow for customization of the damping effect.

Latch solenoid 640 may selectively maintain the drawer 330 in a secure closed state within diagnostic system 300. The latch solenoid 640 may be controlled by the controller of PCBA 450, which may coordinate the opening and closing of the drawer 330. In some aspects, the latch solenoid 640 engages with a corresponding latch mechanism on the diagnostic system 300, ensuring a secure closure.

Drawer closed sensor 650 may be used to verify the containment of a biological sample within diagnostic system 300. The drawer closed sensor 650 may transmit a positional state of the drawer 330 to the controller, which may then provide feedback to the user regarding the status of the sample via display 310. In some aspects, the drawer closed sensor 650 may be a magnetic sensor that detects the presence of a magnet on the drawer, indicating that it is in the closed position.

The linear guide 660 ensures that the drawer 330 moves along a defined pathway with minimal friction and maximal precision. The linear guide 660 may support and stabilize the movement of the drawer 330, reducing wear and tear on the components and enhancing the overall smoothness of operation. The linear guide 660 may maintain alignment and prevent lateral movement, thereby contributing to the accuracy and reliability of the sample handling process.

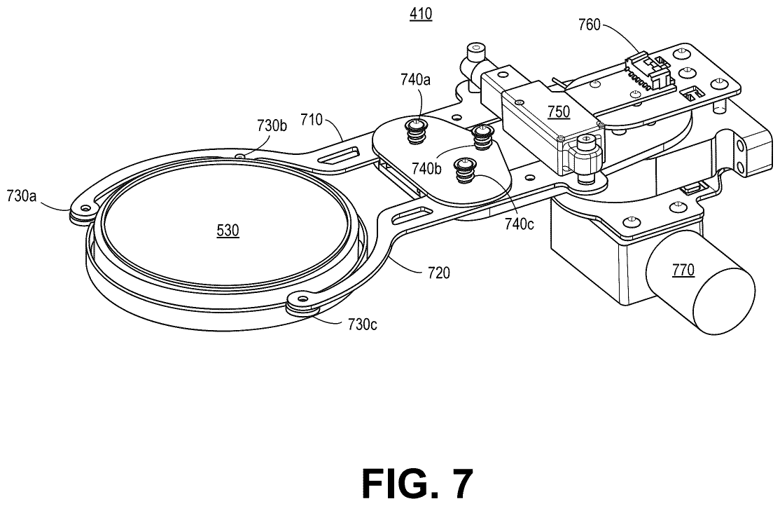

With reference to FIG. 7, shown is a robotic manipulator 410 according to various embodiments of the present disclosure. In some aspects, the robotic manipulator 410 may include a first gripping arm 710 and a second gripping arm 720. The first gripping arm 710 may be defined by a first length and may include a first roller 730a. The first roller 730a may be located at a first distal end of the first gripping arm 710. A second roller 730b may be positioned at another location along the first gripping arm 710. The second gripping arm 720 may be defined by a second length that is less than the first length of the first gripping arm 710. The second gripping arm 720 may include a third roller 730c that may be mounted at a first distal end of the second gripping arm 720. The second distal end of the first gripping arm may be pivotally connected about a first axis to the second distal end of the second gripping arm 720.

A plurality of compression springs 740a, 740b, and 740c may be employed to provide tension between the first gripping arm 710 and the second gripping arm 720. These compression springs 740a-740c are configured to allow the gripping arms to move relative to each other, accommodating sample holder 530. In some embodiments, the sample holder 530 may be a petri dish. The biological sample may be sealed within the petri dish using a thixotropic adhesive.

An actuator 750 may be attached to both the first gripping arm 710 and the second gripping arm 720. The actuator 750 may be responsible for counteracting the tension provided by the compression springs 740a-740c by extending from a first length to a second length. In some aspects, the compression springs 740a-740c are helical springs that are used to provide force between the first gripping arm 710 and second gripping arm 720 to sample holder 530. This extension and contraction of the actuator 750 may allow the arms to grip and release sample holder 530. In some aspects, the actuator 750 may be a finger actuator. The robotic manipulator 410 may include an anti-backlash spring to maintain the angular position of the first gripping arm 710 in relation to the second gripping arm 720 when the arm grips sample holder 530.

In some aspects, an angle sensor 760 may be included to determine the relative position of the first gripping arm 710 in relation to the second gripping arm 720. The angle sensor 760 may provide feedback for control purposes. The angle sensor 760 enables the robotic manipulator 410 to determine the correct angle to grip sample holder 530. A motor 770 may be utilized to rotate the robotic gripper about a second axis perpendicular to the first axis, enabling additional flexibility in object transportation and storage.

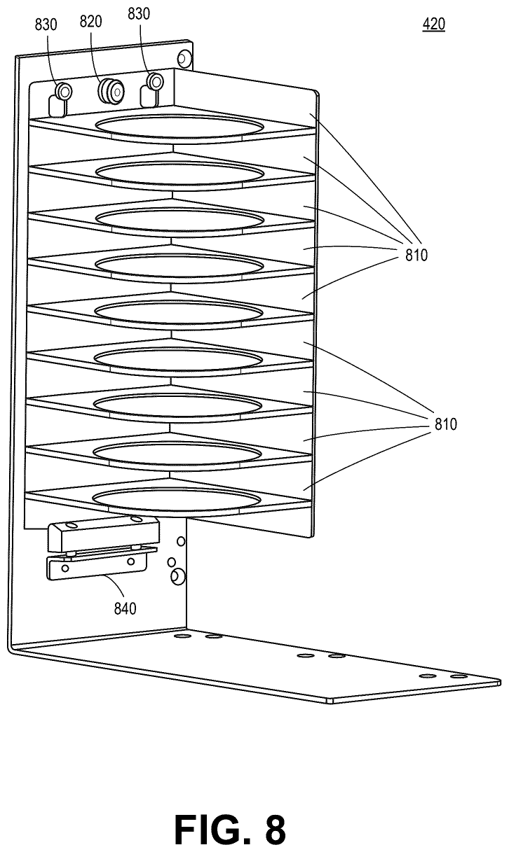

The diagnostic system 300 may contain a repository 420 such as the one shown in FIG. 8. The repository 420 may be used to store sample holder 530 within the diagnostic system 300. The repository 420 may include multiple slots 810. Each slot 810 may store one sample holder 530. The slots 810 may be arranged in a vertical fashion where each slot is stacked on top of each other. The repository 420 may be connected to the diagnostic system 300 via thumb screw 820. The repository 420 may be properly aligned for connection to diagnostic system 300 using alignment features 520 to hook onto hotel capture cone 830. The repository 420 may be connected via thumb screw 820 to a wall of diagnostic system 300. In some aspects, a spring latch 840 may be implemented within repository 420 to secure the bottom of repository 420 to the wall of diagnostic system 300.

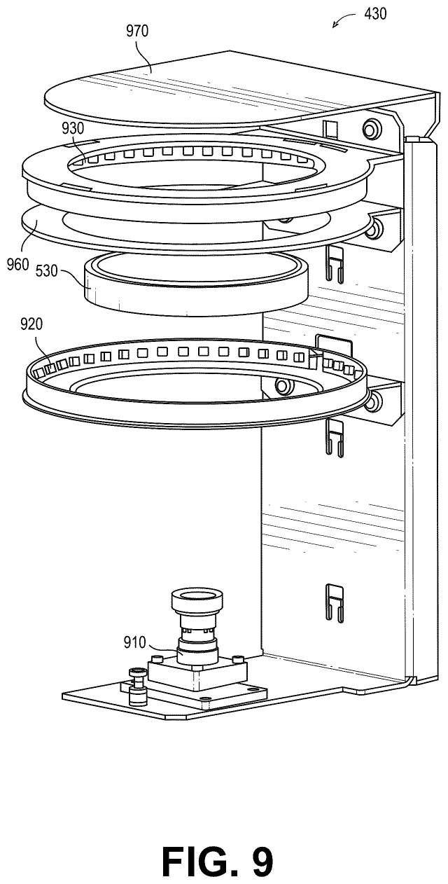

Shown in FIG. 9 is an exemplary embodiment of optic assembly 430. Optic assembly 430 may perform a variety of optical analyses on biological samples contained in sample holder 530. Optic assembly 430 may integrate several advanced components that may work together to capture high-quality images and perform precise analysis. The components of optic assembly 430 may include camera 910, front light 920, back light 930, baffle 960, and backdrop 970. Optic assembly 430 may be controlled by PCBA 450 of diagnostic system 300.

Camera 910 may be used to capture detailed images of biological samples contained in sample holder 530. Camera 910 may be a high-resolution digital imaging device that records images of biological samples illuminated by the optic assembly 430 lighting system. In some embodiments camera 910 may be digital microscope that may perform microscopy analyses. The digital microscope may be equipped with multiple imaging devices of the same or different types that are positioned at different angles relative to the sample holder 530. Imaging devices may be CCD cameras, arrays of photomultiplier tubes, or other suitable imaging devices. The imaging devices may include multiple reconfigurable lenses to allow for adjustable zoom. The controller of PCBA 450 may adjust the camera 910 to focus on the biological sample. The camera 910 may capture multiple images of the sample holder 530 at different focal planes to generate a holographic representation of the sample.

Optic assembly 430 may utilize front light 920 and back light 930 to enhance image contrast. Front light 920 and back light 930 may consist of an array of LEDs or other light sources positioned to shine directly onto sample holder 530. Front light 920 may be positioned below sample holder 530 in order to enhance the visibility of surface features of the biological sample. Front light 920 may highlight the surface details such as texture and contours. Front light 920 may facilitate optical analyses performed by the diagnostic system 300, such as fluorescence microscopy, where clear surface illumination may be required for accurate imaging. Back light 930 may be positioned above sample holder 530 in order to enhance the visibility of the internal structures of the biological sample. Back light 930 may shine light through the biological sample to create a silhouette effect that enhances the contrast of the internal structures of the sample. Back light 930 may facilitate diagnostic system 300 may perform optical analyses such as phase-contrast microscopy that require the differentiation of translucent or semi-transparent features within the biological sample. Back light 930 may help reveal details that might be obscured by front lighting alone.

Optic assembly 430 may utilize a baffle 960 to minimize stray light and prevent glare. Baffle 960 facilitates camera 910 in capturing high-contrast images. Baffle 960 may be a light-shielding component that surrounds the sample area, blocking unwanted ambient light from entering the image field. By reducing stray light and preventing glare, the baffle 960 ensures that the images captured by the camera 910 are clear and free from visual noise.

Backdrop 970 may provide a uniform background for the biological sample, enhancing image clarity and contrast in optic assembly 430. The backdrop 970 may be a uniformly colored surface placed behind the sample holder 530. Backdrop 970 may create a consistent and neutral background that may improve the contrast between the sample and its surroundings. Backdrop 970 aids in optical analyses that require high-contrast visualization, such as digital holographic microscopy and spectrophotometric analyses. The backdrop 970 helps ensure that the biological sample stands out clearly in the captured images.

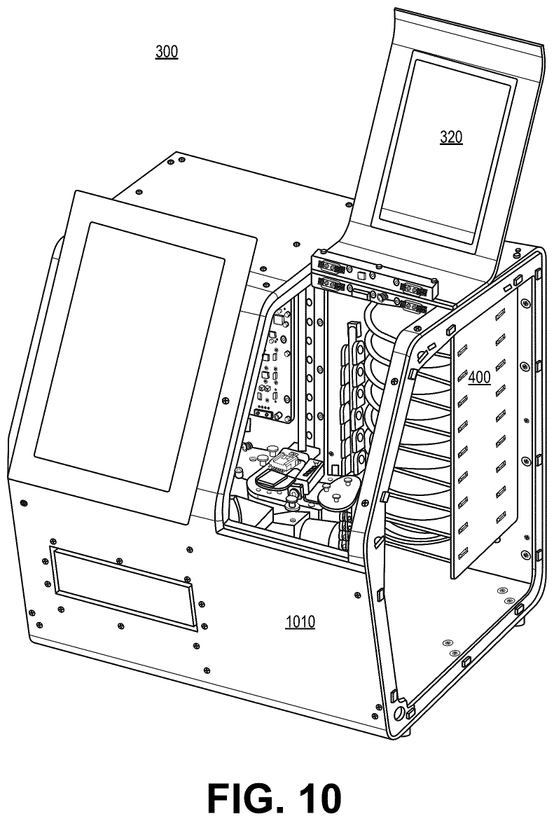

With reference to FIG. 10, shown is the exterior of diagnostic system 300 according to some embodiments. The exterior of diagnostic system 300 may include a front skin assembly 1010. The front skin assembly 1010 may be made of a variety of materials including but not limited to plastic, metal, composite materials, silicone, or stainless steel. The diagnostic system 300 may include a door 320. The door 320 may include a window that enables a user to see inside the diagnostic system 300 when the door is closed. The window allows a user to view the biological samples within the repository 420.

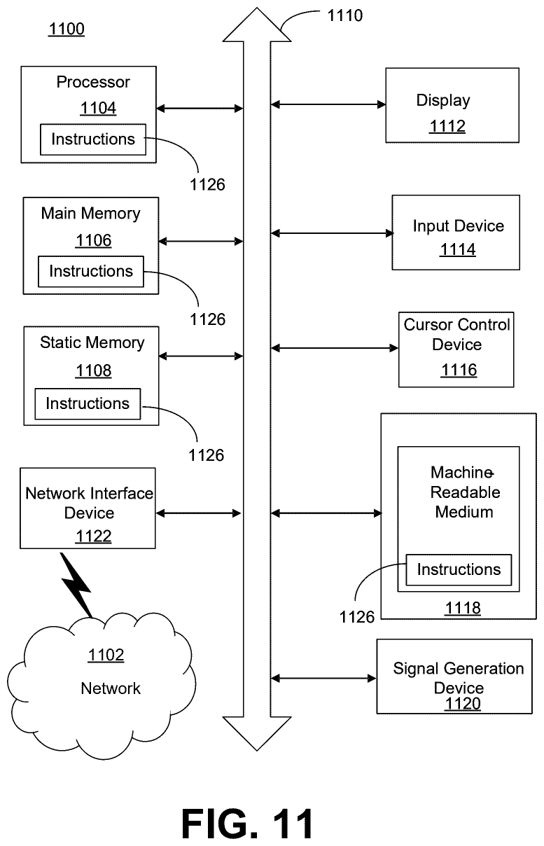

FIG. 11 depicts an exemplary diagrammatic representation of a machine in the form of a computer system 1100 within which a set of instructions, when executed, may cause the machine to perform any one or more of the methods described above. One or more instances of the machine can operate, for example, as a computing device, processor, controller, or other device associated with or illustrated in FIGS. 1-10. In some examples, the machine may be connected (e.g., using a network 1102) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 1100 may include a processor (or controller) 1104 (e.g., a central processing unit (CPU)), a graphics processing unit (GPU, or both), a main memory 1106 and a static memory 1108, which communicate with each other via a bus 1110. The computer system 1100 may further include a display unit 1112 (e.g., a liquid crystal display (LCD), a flat panel, or a solid-state display). Computer system 1100 may include an input device 1114 (e.g., a keyboard), a cursor control device 1116 (e.g., a mouse), a disk drive unit 1118, a signal generation device 1120 (e.g., a speaker or remote control) and a network interface device 1122. In distributed environments, the examples described in the subject disclosure can be adapted to utilize multiple display units 1112 controlled by two or more computer systems 1100. In this configuration, presentations described by the subject disclosure may in part be shown in a first of display units 1112, while the remaining portion is presented in a second of display units 1112.

The disk drive unit 1118 may include a tangible computer-readable storage medium on which is stored one or more sets of instructions (e.g., instructions 1126) embodying any one or more of the methods or functions described herein, including those methods illustrated above. Instructions 1126 may also reside, completely or at least partially, within main memory 1106, static memory 1108, or within processor 1104 during execution thereof by the computer system 1100. Main memory 1106 and processor 1104 also may constitute tangible computer-readable storage media.

While examples of a system for intake, processing, and analysis of biological samples have been described in connection with various computing devices/processors, the underlying concepts may be applied to any computing device, processor, or system capable of intake, processing, and analysis of biological samples. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for handling and transporting diagnostic samples. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with intake, processing, and analysis of biological samples as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for implementing diagnostic testing as described herein. When implemented on a general-purpose processor, the program code combines with the processor to provide a unique device that operates to invoke the functionality of intake, processing, and analysis of biological samples.

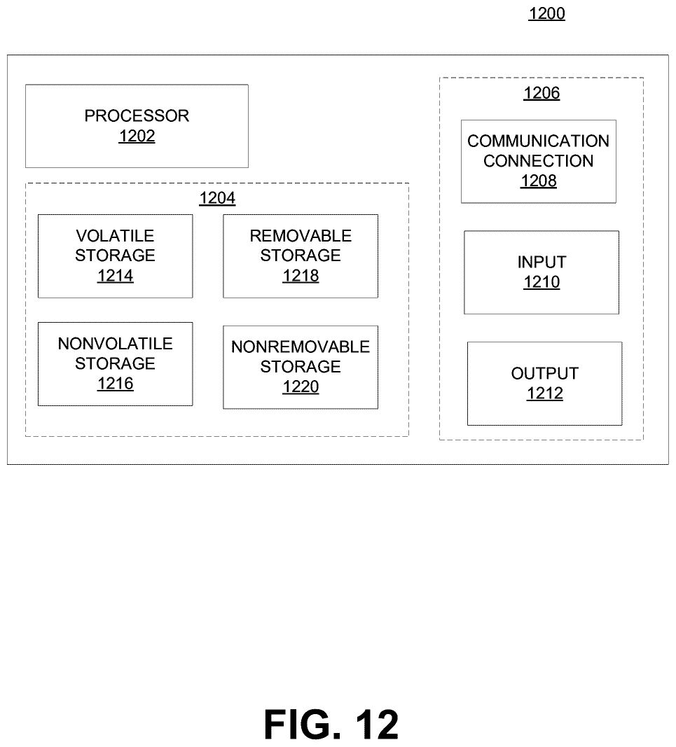

FIG. 12 is a block diagram of a computing device 1200 that may be connected to or comprise a component of one or more devices of FIGS. 1-11. Computing device 1200 may comprise hardware or a combination of hardware and software. The functionality to handle and transport diagnostic samples may reside in one or a combination of computing devices 1200. Computing device 1200 depicted in FIG. 12 may represent or perform functionality of an appropriate computing device 1200, or a combination of computing devices 1200, such as, for example, a component or various components of a diagnostic system, a computing device, a processor, a server, a gateway, a database, a firewall, a router, a switch, a modem, an encryption tool, a virtual private network (VPN), a network access control (NAC) device, a secure web gateway, or the like, or any appropriate combination thereof. It is emphasized that the block diagram depicted in FIG. 12 is exemplary and not intended to imply a limitation to a specific example or configuration. Thus, computing device 1200 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Computing device 1200 may comprise a processor 1202 and a memory 1204 coupled to processor 1202. Memory 1204 may contain executable instructions that, when executed by processor 1202, cause processor 1202 to effectuate operations associated with a diagnostic system. As evident from the description herein, computing device 1200 is not to be construed as software per se.

In addition to processor 1202 and memory 1204, computing device 1200 may include an input/output system 1206. Processor 1202, memory 1204, and input/output system 1206 may be coupled together (coupling not shown in FIG. 12) to allow communications between them. Each portion of computing device 1200 may comprise circuitry for performing functions associated with each respective portion. Thus, each portion may comprise hardware, or a combination of hardware and software. Accordingly, each portion of computing device 1200 is not to be construed as software per se. Input/output system 1206 may be capable of receiving or providing information from or to a communications device or other network entities configured for intake, processing, and analysis of biological samples. For example, input/output system 1206 may include a wireless communication (e.g., 3G/4G/5G/GPS) card. Input/output system 1206 may be capable of receiving or sending video information, audio information, control information, image information, data, or any combination thereof. Input/output system 1206 may be capable of transferring information with computing device 1200. In various configurations, input/output system 1206 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 1206 may comprise a Wi-Fi finder, a two-way GPS chipset or equivalent, or the like, or a combination thereof.

Input/output system 1206 of computing device 1200 also may contain a communication connection 1208 that allows computing device 1200 to communicate with other devices, network entities, or the like. Communication connection 1208 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 1206 also may include an input device 1210 such as keyboard, mouse, pen, voice input device, or touch input device. Input/output system 1206 may also include an output device 1212, such as a display, speakers, or a printer.

Processor 1202 may be capable of performing functions associated with a diagnostic system, such as functions for intake, processing, and analysis of biological samples, as described herein. For example, processor 1202 may be capable of, in conjunction with any other portion of computing device 1200, one or more functions associated with a diagnostic device, as described herein.

Memory 1204 of computing device 1200 may comprise a storage medium having a concrete, tangible, physical structure. As is known, a signal does not have a concrete, tangible, physical structure. Memory 1204, as well as any computer-readable storage medium described herein, is not to be construed as a signal. Memory 1204, as well as any computer-readable storage medium described herein, is not to be construed as a transient signal. Memory 1204, as well as any computer-readable storage medium described herein, is not to be construed as a propagating signal. Memory 1204, as well as any computer-readable storage medium described herein, is to be construed as an article of manufacture.

Memory 1204 may store any information utilized in conjunction with diagnostic testing. Depending upon the exact configuration or type of processor, memory 1204 may include a volatile storage 1214 (such as some types of RAM), a nonvolatile storage 1216 (such as ROM, flash memory), or a combination thereof. Memory 1204 may include additional storage (e.g., a removable storage 1218 or a non-removable storage 1220) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by computing device 1200. Memory 1204 may comprise executable instructions that, when executed by processor 1202, cause processor 1202 to effectuate operations associated with diagnostic testing.

While the disclosed systems have been described in connection with the various examples of the various figures, it is to be understood that other similar implementations may be used, or modifications and additions may be made to the described examples of a diagnostic system without deviating therefrom. For example, one skilled in the art will recognize that a diagnostic system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—intake, processing, and analysis of biological samples—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

Overall, the embodiments of the present invention provide a highly automated and efficient system for the intake, processing, and analysis of biological samples, with applications in medical diagnostics, research, and healthcare.

This written description uses examples to enable any person skilled in the art to practice the claimed subject matter, including making and using any devices or systems and performing any incorporated methods. Other variations of the examples are contemplated herein.

What is claimed:

1. A method for the automated intake and analysis of biological samples, the method comprising:
receiving, by a drawer of a testing device, a sample holder comprising a biological sample;
transporting, by a robotic manipulator, the sample holder from the drawer to a recessed cavity within a repository;
maintaining, by a heater, a predefined temperature within the repository during a growth period of the biological sample;
moving, by the robotic manipulator, the sample holder to an optic assembly;
removing, by the robotic manipulator, a coverslip from the sample holder;
capturing, by the optic assembly, an image of the biological sample;
determining, based on the image, one or more characteristics of the biological sample; and
executing, based on the one or more characteristics, one or more actions.

2. The method of claim 1, wherein the one or more actions comprise returning the sample holder to the repository, ejecting the sample holder from the drawer, or maintaining the sample holder within the optic assembly for additional imaging.

3. The method of claim 1, wherein the growth threshold period is based on a type of the biological sample.

4. The method of claim 1, wherein capturing the image comprises using front lighting and back lighting to enhance image contrast.

5. The method of claim 1, further comprising sealing the biological sample within the sample holder using a thixotropic adhesive.

6. The method of claim 1, wherein the robotic manipulator is operated based on instructions received from a controller.

7. The method of claim 1, further comprising aligning the sample holder within the repository.

8. The method of claim 1, further comprising adjusting the optic assembly to focus on the biological sample prior to capturing the image.

9. The method of claim 1, wherein determining the one or more characteristics comprises comparing the image to a database of known samples.

10. A system, comprising:
a memory; and
at least one computing device in communication with the memory, the at least one computing device being configured to at least:
receive, by a drawer of a testing device, a sample holder comprising a biological sample;
transport, by a robotic manipulator, the sample holder from the drawer to a recessed cavity within a repository;
maintain, by a heater, a predefined temperature within the repository during a growth period of the biological sample;
move, by the robotic manipulator, the sample holder to an optic assembly;
remove, by the robotic manipulator, a coverslip from the sample holder;
capture, by the optic assembly, an image of the biological sample;
determine, based on the image, one or more characteristics of the biological sample; and
execute, based on the one or more characteristics, one or more actions.

11. The system of claim 10, wherein the one or more actions comprise returning the sample holder to the repository, ejecting the sample holder from the drawer, or maintaining the sample holder within the optic assembly for additional imaging.

12. The system of claim 10, wherein the growth threshold period is based on a type of the biological sample.

13. The system of claim 10, wherein the at least one computing device is further configured to use front lighting and back lighting to enhance image contrast while capturing the image of the biological sample.

14. The system of claim 10, wherein the at least one computing device is further configured to seal the biological sample within the sample holder using a thixotropic adhesive.

15. The system of claim 10, wherein the at least one computing device is further configured to align the sample holder within the repository.

16. The system of claim 10, wherein the at least one computing device is further configured to adjust the optic assembly to focus on the biological sample prior to capturing the image.

17. The system of claim 10, wherein the at least one computing device is further configured to compare the image to a database of known samples.

18. The system of claim 10, wherein the robotic manipulator is operated based on instructions received from a controller.

19. One or more computing devices, comprising one or more processors, configured to:
receive, by a drawer of a testing device, a sample holder comprising a biological sample;
transport, by a robotic manipulator, the sample holder from the drawer to a recessed cavity within a repository;
maintain, by a heater, a predefined temperature within the repository during a growth period of the biological sample;
move, by the robotic manipulator, the sample holder to an optic assembly;
remove, by the robotic manipulator, a coverslip from the sample holder;
capture, by the optic assembly, an image of the biological sample;
determine, based on the image, one or more characteristics of the biological sample; and
execute, based on the one or more characteristics, one or more actions.

20. The one or more computing devices of claim 19, wherein the one or more actions comprise returning the sample holder to the repository, ejecting the sample holder from the drawer, or maintaining the sample holder within the optic assembly for additional imaging.
